(19) United States
(12) Patent Application Publication
(10) Pub. No.: US 2022/0115638 A1
(43) Pub. Date: Apr. 14, 2022

(54) METALLIC LITHIUM BASED BATTERY ELECTRODES, FORMATION THEREOF, AND USES THEREOF

(71) Applicant: Honda Motor Co., Ltd., Tokyo (JP)

(72) Inventor: Avetik HARUTYUNYAN, Santa Clara, CA (US)

(21) Appl. No.: 17/069,313

(22) Filed: Oct. 13, 2020

(51) Int. Cl. H01M 4/133; H01M 4/66; H01M 10/0525; H01M 4/04; H01M 4/02

(52) U.S. Cl. CPC H01M 4/133; H01M 4/661; H01M 2004/028; H01M 4/0428; H01M 10/0525

(57) ABSTRACT

Aspects of the present disclosure generally relate to lithium metal based electrodes, formation thereof, and uses thereof. In an aspect is provided an electrode that includes a current collector layer, a boron-carbon containing nanostructure, and a lithium metal layer. In another aspect is provided an electrode that includes a current collector layer, boron-carbon containing graphene, and a lithium metal layer. In another aspect is provided an electrode that includes a current collector layer, graphene, a plurality of boron-carbon containing nanotubes, and a lithium metal layer. Batteries including such electrodes are also described.

### FIELD

Aspects of the present disclosure generally relate to lithium metal based electrodes, formation thereof, and uses thereof.

### BACKGROUND

The demand for high-energy density batteries has increased with the development of electric vehicles and portable electronic devices. The use of metallic Li as an electrode provides high energy density for Li-ion batteries. However, during charge-discharge cycling, Li metal electrodes problematically develop dendritic (tree-like) structures, which might reduce battery lifespan. Carbon nanomaterial-based Li storage has been considered an alternative way to achieve high energy density for Li ion battery electrodes. Indeed, carbon nanomaterials have been expected to have high storage capacities due to their high surface-to-mass ratio, as compared to three-dimensional (3D) bulk materials. However, for experimental studies of Li storage on graphene, it is still not clear whether graphene could have a higher capacity than graphite, which is used commercially as an anode with a maximum capacity of 372 mAh/g, e.g., one Li atom per six carbon atoms (340 mAh/g, including Li own weight). Moreover, the carbon nanomaterials used as substrates for metallic Li do not overcome the dendrite problem for at least the reason that the interaction between carbon nanomaterials and Li atoms is much weaker than the lithium-lithium interaction.

There is a need for improved metallic lithium based electrodes that eliminates, or at least suppresses, lithium dendrite formation during cycling.

### SUMMARY

Aspects of the present disclosure generally relate to lithium metal based electrodes, formation thereof, and uses thereof.

In an aspect, an electrode that includes a boron-carbon containing nanostructure is provided. The electrode further includes a current collector layer and a lithium metal layer.

In another aspect, an electrode that includes boron-carbon containing graphene is provided. The electrode further includes a current collector layer and a lithium metal layer.

In another aspect, an electrode that includes a plurality of boron-carbon containing nanotubes is provided. The electrode further includes a current collector layer, graphene, and a lithium metal layer.

In another aspect, a battery is provided. The battery includes an anode and a cathode. The cathode includes an electrode described herein.

In another aspect, a process for producing an electrode is provided. The process includes depositing a first carbon source on a metal substrate to form graphene, depositing a metal catalyst on the graphene, and introducing a boron source and a second carbon source to the metal catalyst to form a boron-carbon containing nanotube. The process further includes depositing lithium on the boron-carbon containing nanotube to produce an electrode.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, for the disclosure may admit to other equally effective aspects.

FIG. 1A is an illustration of lithium clusters on a comparative graphene surface.

FIG. 1B is an illustration of absorbed lithium atoms on the surface of an example boron-carbon containing graphene according to at least one aspect of the present disclosure.

FIG. 2A is an illustration of an example boron-carbon containing graphene according to at least one aspect of the present disclosure.

FIG. 2B is an illustration of an example boron-carbon containing nanotube according to at least one aspect of the present disclosure.

FIG. 3A is an illustration of an example electrode according to at least one aspect of the present disclosure.

FIG. 3B is an illustration of an example electrode according to at least one aspect of the present disclosure.

FIG. 3C is an illustration of an example battery according to at least one embodiment of the present disclosure.

FIG. 4A is a scanning electron microscope (SEM) image of example boron-carbon containing nanotubes according to at least one aspect of the present disclosure.

FIG. 4B is a SEM image of example boron-carbon containing nanotubes according to at least one aspect of the present disclosure.

FIG. 4C is a SEM image of example boron-carbon containing nanotubes according to at least one aspect of the present disclosure.

FIG. 5A is a Raman spectrum at 488 nm of comparative carbon nanotubes and example boron-carbon containing nanotubes according to at least one aspect of the present disclosure.

FIG. 5B is a Raman spectrum at 514 nm of comparative carbon nanotubes and example boron-carbon containing nanotubes according to at least one aspect of the present disclosure.

FIG. 5C is a Raman spectrum at 633 nm of comparative carbon nanotubes and example boron-carbon containing nanotubes according to at least one aspect of the present disclosure.

To facilitate understanding, identical reference numerals have been used, where possible, to designate identical elements that are common to the figures. It is contemplated that elements and features of one example may be beneficially incorporated in other examples without further recitation.

### DETAILED DESCRIPTION

Aspects of the present disclosure generally relate to lithium metal based electrodes, formation thereof, and uses thereof. The inventor has discovered that boron-carbon containing nanomaterials, as part of an electrode, can eliminate, or at least suppress, dendrite formation during charge-discharge cycling of a battery. Accordingly, the electrodes described herein, and use thereof in batteries are more stable and can present improved lifetime over conventional electrodes and batteries.

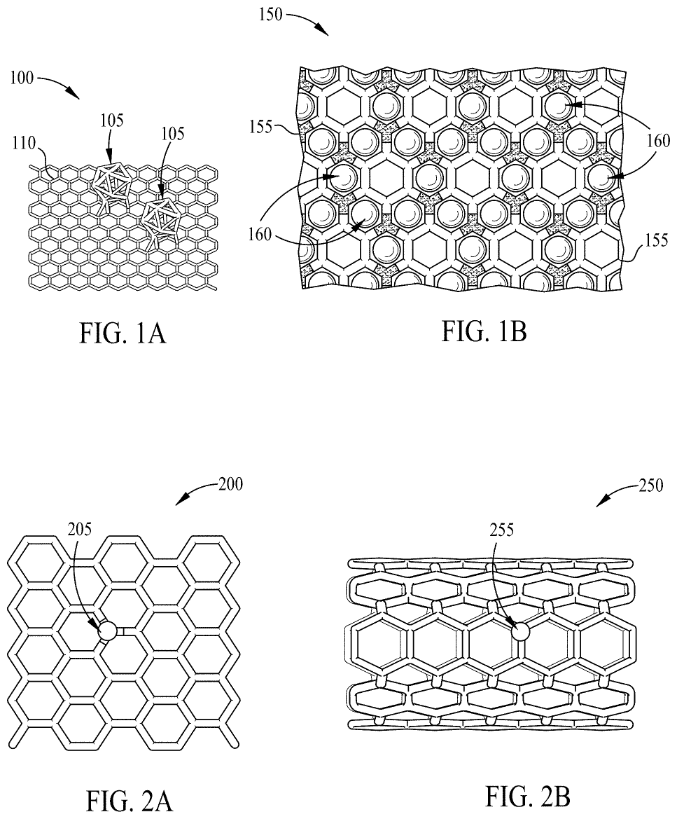

Conventional nanomaterial-based lithium storage can be ineffective in suppressing dendrite formation during cycling for at least the reason that the nanomaterials typically used for substrates form weaker interactions with lithium than the lithium-lithium interaction. However, doping the nanomaterials, e.g., graphene and/or nanotubes, with boron atoms can change the chemical structure and nature of the nanomaterials such that the boron-carbon containing nanomaterials interact more strongly with lithium than the lithium-lithium interaction. For instance, a monolayer having C₃B moieties has a capacity (in milliampere hours per gram, mAh/g) of 714 mAh/g (as Li_{1.25}C₃B), and the capacity of stacked C₃B is 857 mAh/g (as Li_{1.5}C₃B), which is about twice as large as graphite's 372 mAh/g (as LiC₆). Since boron-modified nanomaterials have higher absorption energy than the Li—Li atomic interaction, the Li ions will prefer to be plated flat on the boron-carbon surfaces instead of growing the dendrites during the charge-discharge cycling. This phenomenon is illustrated in FIGS. 1A and 1B. FIG. 1A illustrates conventional graphene without boron atoms. The lithium is not plated flat on the graphene. Instead, the lithium metal grows into clusters 105 and dendrites on top of the graphene surface 110. In contrast, and as shown in the non-limiting example 150 of FIG. 1B, when certain carbon atoms of the graphene sheet are replaced by boron atoms, the lithium atoms 160 can absorb on the surface of the boron-carbon containing graphene sheet 155. Accordingly, the boron-carbon containing nanomaterials of the present disclosure can exhibit improved suppression of dendrites, improved cycle life and Coulombic efficiency, reduced short circuits and failure, as compared to conventional materials.

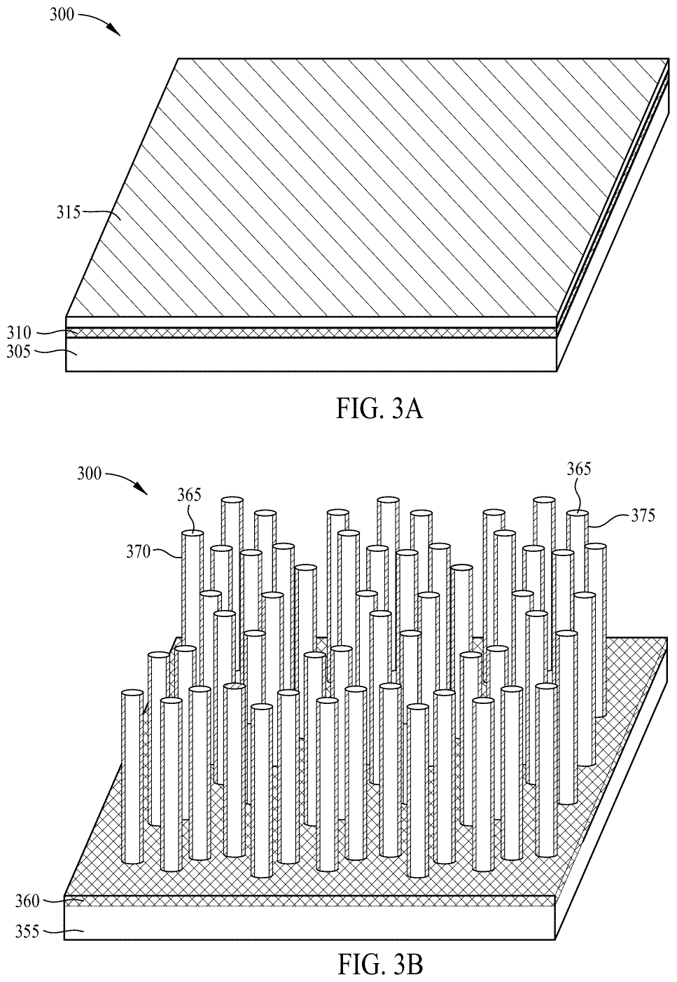

FIGS. 2A and 2B are illustrations of boron-carbon containing nanostructures, boron-carbon containing graphene 200 and boron-carbon containing nanotube 250 where only one boron atom 205, 255 is shown for clarity. In the boron-carbon containing nanostructures, at least one boron atom substitutes for at least one carbon atom.

### Electrode

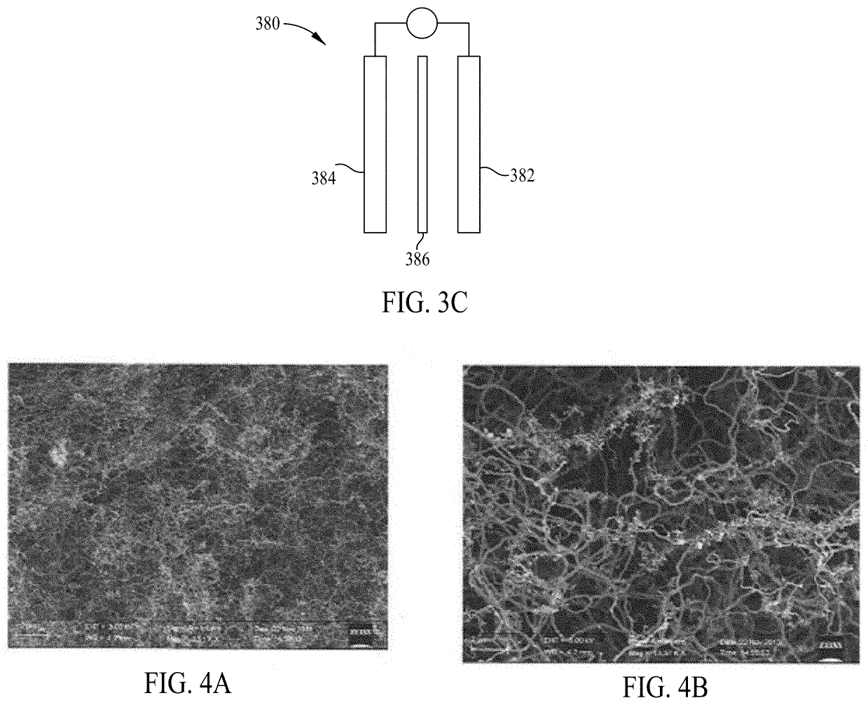

FIG. 3A is an example electrode 300 according to at least one aspect of the present disclosure. The example electrode 300 can be a cathode. The example electrode 300 can include various components and each component can be in the form of a layer. In some aspects, the electrode can include a current collector 305, a boron-carbon containing nanostructure 310 (such as boron-carbon containing graphene), and lithium metal 315. In at least one aspect, the boron-carbon containing nanostructure 310 can be, e.g., disposed on at least a portion of a surface of the current collector 305. In some aspects, the lithium metal 315 can be, e.g., disposed on at least a portion of a surface of the boron-carbon containing nanostructure 310.

The current collector 305, which can be in the form of a layer, can include any suitable material known in the art. Non-limiting examples of the current collector 305 can include aluminum, copper, nickel, silver, titanium, sintered carbon, stainless steel, or a combination thereof, such as aluminum, copper, nickel, or a combination thereof. In some aspects, the lithium metal 315, which can be in be in the form of a layer, can include lithium metal and/or a lithium metal alloy. The lithium metal alloy can include a lithium metal and a metal/metalloid alloyable with lithium metal and/or an oxide of the metal/metalloid. Non-limiting examples of the metal/metalloid alloyable with lithium metal and/or an oxide thereof can include Si, Sn, Al, Ge, Pb, Bi, Sb, a Si—Z alloy (wherein Z can be an alkaline metal, an alkaline earth metal, a Group 13 to 16 element, a transition metal, a rare earth element, or a combination thereof, except for Si), a Sn—Z alloy (wherein Z can be an alkaline metal, an alkaline earth metal, a Group 13 to 16 element, a transition metal, a rare earth element, or a combination thereof, except for Sn), MnOₓ (wherein 0<x≤2), or a combination thereof. In some aspects, Z for Si—Z and Sn—Z can include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, oxides thereof, or a combination thereof. For example, the oxide of a metal/metalloid alloyable with lithium metal can be a lithium titanium oxide, a vanadium oxide, a lithium vanadium oxide, SnO₂, SiOₓ (wherein 0<x<2), or the like. A combination comprising at least one of the foregoing can also be used.

The example electrode 300 can include a boron-carbon containing nanostructure 310. The boron-carbon containing nanostructure 310, which can be in the form of a layer, can include a nanostructure material selected from boron-carbon containing nanotube, boron-carbon containing graphene, boron-carbon containing fiber, boron-carbon containing nanofiber, boron-carbon containing hexagonal sheet, boron-containing meso-phase carbon, boron-containing soft carbon, boron-containing hard carbon, boron-containing carbon black, boron-containing activated carbon, and a combination thereof. In some aspects, the electrode may additionally include carbon nanotube, graphene, carbon fiber, carbon nanofiber, meso-phase carbon, soft carbon, hard carbon, carbon black, activated carbon, or a combination thereof. That is, at least one of the nanostructure materials is boron-containing.

FIG. 3B is an example electrode 350 according to at least one aspect of the present disclosure. The example electrode 350 can be a cathode. The example electrode 350 can include various components and each component can be in the form of a layer. In some aspects, the electrode can include a current collector 355, a nanostructure 360, a boron-carbon containing nanostructure 365 (such as boron-carbon containing nanotubes), and lithium metal 370. Non-limiting examples of the current collector 355, the nanostructure 360, and the boron-carbon containing nanostructure 365 are provided above. In at least one aspect, the nanostructure 360 can be, e.g., can be disposed on at least a portion of a surface of the current collector 355. In some aspects, the boron-carbon containing nanostructure 365 can be disposed on at least a portion of a surface of the nanostructure 360. In some aspects, the lithium metal 370 can be, e.g., disposed on at least a portion of a surface of the boron-carbon containing nanostructure 365.

In some aspects, the synthesis of boron-carbon containing nanostructures, such as boron-carbon containing graphene, can be performed by using a bubbler-assisted chemical vapor deposition (BA-CVD) system. The resulting boron-carbon containing nanostructures have boron-carbon bonds within the boron-carbon containing nanostructure lattice, such as boron-carbon trimers bonded within a hexagonal lattice of graphene.

The BA-CVD system deposits boron-carbon containing nanostructures onto a substrate such as a current collector (e.g., copper foil) and/or graphene. In some aspects, the boron source can include, e.g., triethylborane, boron powder, and/or diborane. In at least one aspect, the carbon source can include methane, thiophene, n-hexane, xylenes, alcohols, or a combination thereof. Tuning the ratio of boron source to carbon source can control the amount of boron in the boron-carbon containing nanostructure. A BA-CVD process can be performed at elevated temperature (a “heating process”). A heating process may be performed under an environment including an non-reactive gas-containing atmosphere (e.g., Ar and/or N₂), a carbon-containing atmosphere, and/or a boron-carbon containing atmosphere. In some cases, the heating can occur under alternating atmospheres of an inert gas-containing atmosphere, a carbon-containing atmosphere, and/or a boron-carbon containing atmosphere.

In some aspects, boron-carbon containing nanotubes can be grown on graphene in the presence of a metal catalyst using a BA-CVD system. Generally, this involves exposing the metal catalyst to a vapor phase carbon source and a vapor phase boron source, and then producing carbon nanotubes. Graphene, without boron, can be grown by introducing only hexane into the CVD system.

In at least one aspect, the boron-carbon containing nanotubes can be aligned substantially vertically from the top surface of the graphene. In some aspects, the metal catalyst is formed from a metal catalyst precursor. In at least one aspect, the metal catalyst precursor can include a chromocene, a ferrocene, a cobaltocene, a nickelocene, a molybdocene dichloride, a ruthenocene, a rhodocene, or a combination thereof. These metal precursors can be used alone in the feedgas or can be mixed with other materials including a thiophene, and other vapor phase carbon source components, such as, methane, and/or vapor phase boron sources such as triethylborane. In some instances, the vapor phase carbon source can include other carbon-containing compounds, such as n-hexane, xylenes, alcohols, or a combination thereof. The metal catalyst can include chromium, manganese, iron, cobalt, nickel, copper, molybdenum, ruthenium, rhodium, or a combination thereof. In at least one aspect, the height of the carbon nanotubes can be controlled by the precursor injection time, with typical growth rates at approximately 1 μm/min.

In some aspects, the boron-carbon containing nanotube growth operation can be achieved at a substrate temperature of about 600° C. to about 1,100° C., such as from about 750° C. to about 950° C. It should be noted that a catalyst precursor component that has carbon-containing substituents, such as a cyclopentadienyl ring, can provide both the catalyst metal and a source of vapor phase carbon. Selection of a different catalyst and/or catalyst precursor, as well as the boron source, can impact the temperature used to grow the desired boron-carbon containing nanotubes. For instance, use of a substituted cyclopentadienyl ring and/or a different catalyst metal will affect the deposition of the metal and growth of the boron-carbon containing nanotubes. For example, use of ferrocene in a xylene solution at a ferrocene concentration ranging from about 5 wt % to about 15 wt % can be fed into a CVD system over the graphene substrate with a rate of about 1 mL/h to about 2 mL/h, such as about 1.2 mL/h, for a time period up to, e.g., about 6 hours. Additionally, inclusion of a separate vapor phase carbon source, like methane, to increase the concentration of carbon in the system can affect the growth rate of the boron-carbon containing nanotubes.

Also disclosed herein is a method for producing an array of vertically aligned boron-carbon containing nanotubes by first providing a graphene substrate having a top surface, and then heating the graphene substrate under an environment to a temperature sufficient to coat at least the top surface with a carbon layer. A vapor phase composition containing a catalyst capable of producing carbon nanotubes, a carbon source, and a boron source is then provided and followed by contacting the vapor phase composition with the carbon layer. Particles of the catalyst can be deposited on the carbon layer, and the array of vertically aligned boron-carbon containing nanotubes can be produced on the top surface of the graphene substrate.

In some aspects, the boron-carbon containing nanostructure can have a molar ratio of boron to carbon of about 1:1000 or more boron. In at least one aspect, the molar ratio of boron to carbon can be from about 1:100 to about 1:3, such as from about 1:50 to about 1:3.5, such as from about 1:40 to about 1:4, such as from about 1:30 to about 1:4.5, such as from about 1:25 to about 1:5, such as from about 1:24 to about 1:6, such as from about 1:23 to about 1:7, such as from about 1:22 to about 1:8, such as from about 1:21 to about 1:9, such as from about 1:20 to about 1:10, such from about 1:19 to about 1:11, such as from about 1:18 to about 1:12, such as from about 1:17 to about 1:13, such as from about 1:16 to about 1:14. In some aspects, the molar ratio of boron to carbon can be from about 1:20 to about 1:9. The presence of boron was determined by X-ray photoelectron spectroscopy (XPS) using a Kratos AXIS Ultra spectrometer with an Al Kα X-ray source of 1486.6 eV and under a vacuum of 10⁻⁹ Torr. The atomic percentage of is calculated by the integrated intensity of the C1s and B1s narrow scan peak areas, considering their relative sensitivity factors.

Deposition of lithium onto the boron-carbon containing nanostructure can be performed by electroplating. The electrolyte used for electroplating can be lithium bis(fluorosulfonyl)imide (LiF SI).

### Battery

The present disclosure also relates to uses of the electrode in, e.g., a battery, such as a lithium metal battery. The battery can be a secondary and/or a rechargeable battery. In some aspects, the battery, after charge-discharge cycling, can show little to no dendritic growth. In at least one aspect, the cathode and anode are substantially free of dendrites, e.g., that the battery has a flat thin film even after multiple cycles (e.g., >10,000 cycles), and/or that the metal surface roughness does not change after multiple cycles (e.g., >10,000 cycles).

FIG. 3C is an illustration of an example battery 380 according to at least one embodiment of the present disclosure. The example battery 380 includes a cathode 382 and an anode 384. According to some aspects, the anode is or includes a Li metal. The cathode 382 can include a boron-carbon containing structure, such as a boron-carbon containing nanostructure described herein, e.g., boron-carbon containing graphene, boron-carbon containing nanotube, or combinations thereof. The cathode 382 and the anode are isolated by a separator 386, such as a membrane, film, and/or a composite. Although not shown, the battery 380 includes one or more electrolytes.

The anode 384 that can be used for the battery can be any suitable anode. A non-limiting example of the anode 384 can include an anode current collector and an anode active material layer formed on a surface of the anode current collector. Non-limiting examples of the anode current collector can include aluminum, copper, nickel, silver, titanium, sintered carbon, stainless steel, or a combination thereof, such as aluminum, copper, nickel, or a combination thereof.

The separator 386 can be single or multi-ply. The separator 386 can include at least one layer composed of or including one or more polymers. Illustrative, but non-limiting, examples of such polymers include polyolefins, e.g., polypropylene, polyethylene, polyimidazoles, polybenzimidazole (PBI), polyimides, polyamideimides, polyaramids, polysulfones, polyvinylidene fluoride, aromatic polyesters, polyketones, and/or blends, mixtures, and combinations thereof. Commercial polymer separators include, for example, the Celgard™ line of separators.

In some aspects, the electrolyte can include a liquid electrolyte, a solid electrolyte, a gel electrolyte, a polymer ionic liquid. In at least one aspect, the gel electrolyte can be any suitable gel electrolyte known in the art. For example, the gel electrolyte can include a polymer and a polymer ionic liquid. For example, the polymer can be a solid graft (block) copolymer electrolyte. In some aspects, the solid electrolyte can be, for example, an organic solid electrolyte or an inorganic solid electrolyte. Non-limiting examples of the organic solid electrolyte can include polyethylene derivatives, polyethylene oxide derivatives, polypropylene oxide derivatives, phosphoric acid ester polymer, polyester sulfide, polyvinyl alcohol, polyfluoride vinylidene, and polymers including ionic dissociative groups. A combination comprising at least one of the foregoing can also be used.

A battery with improved capacity retention rate can be manufactured using an electrode (e.g., cathode) according to any of the above-described aspects. A battery of the present disclosure can effectively suppress growth or eliminate growth of lithium dendrites. Additionally, the battery can have a higher energy density compared to conventional Li-ion batteries based on Li-metal oxide active cathode materials. Accordingly, and in some aspects, the battery can be used in such applications and/or can be incorporated into desired devices, e.g., mobile phones, laptop computers, storage batteries for power generating units using wind power or sunlight, electric vehicles, uninterruptable power supplies (UPS), and household storage batteries. The battery can also be used as a unit battery of a medium-large size battery pack or battery module that includes a plurality of battery cells for use as a power source of a medium-large size device.

The following examples are put forth so as to provide those of ordinary skill in the art with a complete disclosure and description of how to make and use aspects of the present disclosure, and are not intended to limit the scope of aspects of the present disclosure. Efforts have been made to ensure accuracy with respect to numbers used (e.g. amounts, dimensions, etc.) but some experimental errors and deviations should be accounted for.

### EXAMPLES

Characterization was performed with scanning electron microscopy (FEI QUANTA™ FEG 650, operating at 20 kV) and micro-Raman spectroscopy (Reinshaw inVia™ Raman microscope, 1 mW laser power).

### Example 1: Electrode Comprising Boron-Carbon Containing Graphene

Example 1A: Synthesis of Boron-Carbon Containing Graphene on a Current Collector. Synthesis of boron-carbon containing graphene is achieved using a bubbler-assisted chemical vapor deposition (BA-CVD) system. A typical method of the synthesis follows. Firstly, copper foils (99.8% purity, 25 μm thick, Alfa Aesar) were cleaned in a diluted HCl aqueous solution (HCl:H₂O=1:3 v/v), dried with an N₂ airbrush and then loaded into a quartz tubing reactor. Before heating the reactor, a mixture of Ar (1000 sccm) and H₂ (50 sccm) was introduced into the reactor to degas the air inside. Subsequently, the reactor was heated to 1000° C. (by temperature ramping discussed below) and kept constant for 10 min in order to anneal the copper foils. After that, a 0.5 M triethylborane (TEB)/hexane solution was bubbled with 1 sccm Ar into the reactor at 1000° C. for 5 min. Finally, the reactor was cooled down to room temperature under a flow of Ar to produce boron-carbon containing graphene. Temperature ramping was as follows: The temperature was increased to 100° C. from time=about 0 min to about 2 min and kept at 100° C. from time=2 min to about 15 min. Then, the temperature was increased to 200° C. from time=about 15 min to about 16 min and kept at 200° C. from time=about 16 min to about 25 min. Then the temperature was increased to 1000° C. from time=about 26 min to about 50 min and keep at 1000° C. from time=about 50 min to about 65 min. After 10 min (e.g., time=about 60 min) of heating at 1000° C., the 0.5 M triethylborane (TEB)/hexane solution was added as described above.

### Example 1B: Deposition of Lithium Metal on Boron-Carbon Containing

Graphene. Deposition of the lithium metal on the boron-carbon containing graphene/current collector structure of Example 1A can be performed according to the following prophetic procedure. The electrochemical reaction can be performed in 2032 coin-type cells using substrates of Example 1A and Li foil as both counter and reference electrodes. The substrates are circular with total area of about 2 cm². The electrolyte is 4M lithium LiFSI (Oakwood Inc.) in 1,2-dimethoxyethane (DME). The LiFSI salt is vacuum-dried (<20 Torr) at 100° C. for 24 h, and DME can be distilled over Na strips. The experiment is conducted inside a glovebox with oxygen levels below 5 ppm. The separator is Celgard™ membrane K2045. Previous to the coin-cell assembly, the substrate is pre-lithiated by putting one drop of electrolyte on the surface of substrate, pressing a Li coin gently against the substrate and leaving it with the Li coin on top for 3 h. After the pre-lithiation, the substrate is assembled in a coin cell using the same Li chip used in the pre-lithiation. The current density for the electrochemical measurements (insertion/extraction and cycling) ranges from 1 to 10 mA cm⁻¹, all performed at room temperature. For the Li plating (discharging process), a time-controlled process with a constant current regime is applied with no cutoff voltage limit. The stripping process (charge process) is set to a constant current regime with a cutoff voltage of 1 V (vs Li⁺/Li).

### Example 2: Electrode Comprising Boron-Carbon Containing Nanotube

### Example 2A: Synthesis of Graphene on Current Collector

Graphene growth on Cu and Ni by low-pressure CVD. Cu and Ni foils (25 mm thick, 99.8%, Alfa Aesar) were used as substrates for monolayer and multi-layer graphene growth, respectively. The foils were loaded into a tubular quartz furnace and purged with Ar/H₂ gas mixture at a flow rate of 50 sccm under 90 mTorr pressure for 20 min, followed by ramping up the furnace temperature to 1000° C. Once the temperature was reached, it was held for 30 min to anneal the foils, followed by the introduction of CH₄ (8 sccm for Cu and 4 sccm for Ni substrates) for 10 min along with the Ar/H₂ gases. Following growth, the samples were cooled down to room temperature at a rate of 30° C./min rate under the Ar/H₂ mixture.

Graphene growth on Cu by atmospheric pressure CVD. Cu foil (25 mm thick, 99.8% purity, Alfa Aesar) was loaded into the center of a tubular quartz furnace and heated to 1000° C. under a constant flow of argon (300 sccm) and hydrogen (30-100 sccm). Once the temperature was reached, it was held for 15 minutes to anneal the Cu foils, followed by the introduction of 1-2 sccm of CH₄ for 30 minutes along with the Ar/H₂ gases. Following growth, the samples were allowed to cool down to room temperature naturally.

### Example 2B: Boron-Carbon Containing Nanotube Growth on Graphene/Current Collector

The graphene on current collector of Example 2A is used for the following procedure for growing boron-carbon containing nanotubes. Carbon nanotubes were grown at ambient pressure via a floating catalyst CVD method using ferrocene and xylene as the catalyst and carbon source, respectively. Ferrocene (10 wt %) was dissolved in xylene through mild sonication. The mixture was then loaded into a syringe and delivered into a quartz tube furnace through a capillary connected to a syringe pump. The capillary was placed such that its exit point was just outside the hot zone of the tube furnace. The substrate (graphene-covered Cu) were loaded into the center of the quartz tube furnace, which was heated to the growth temperature of (700-800° C.) under a constant flow of argon (500 sccm) and hydrogen (60-120 sccm). After the furnace reached the growth temperature, the ferrocene/xylene mixture was injected continuously into the tube furnace at a rate of 1.2 mL/h for the duration of the carbon nanotube growth (few seconds to 6 hours) and 0.5 M triethylborane (TEB)/hexane solution was bubbled with 1 sccm Ar into the reactor. At the end of the growth period the furnace was turned off and allowed to cool down to room temperature under the argon/hydrogen flow. The growth process produced vertically aligned multi-walled carbon nanotubes that grow via root growth on the graphene-covered substrates. The heights of the carbon nanotube forests could be controlled by the precursor injection time, with typical growth rates at about 1 mm/min.

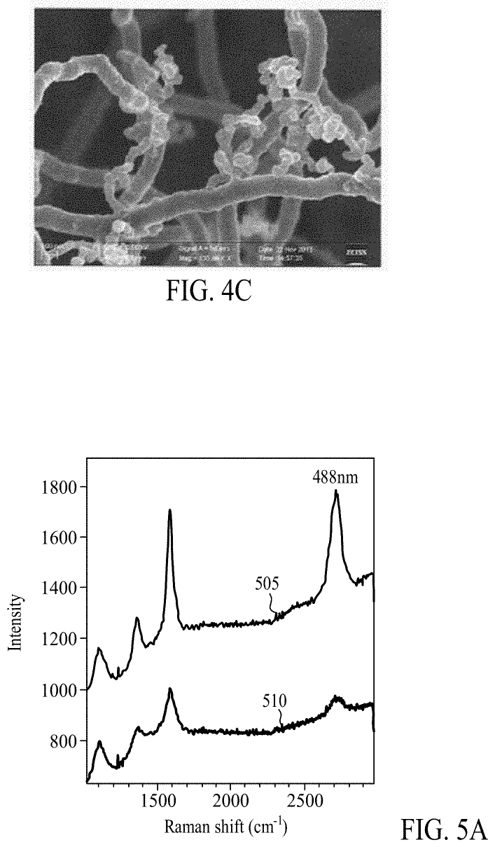

FIGS. 4A-4C are SEM images of example boron-carbon containing nanotubes at various resolutions. As shown by the heavily kinked and distorted nanotube structures, the images confirm that certain carbon atoms have been replaced by boron atoms.

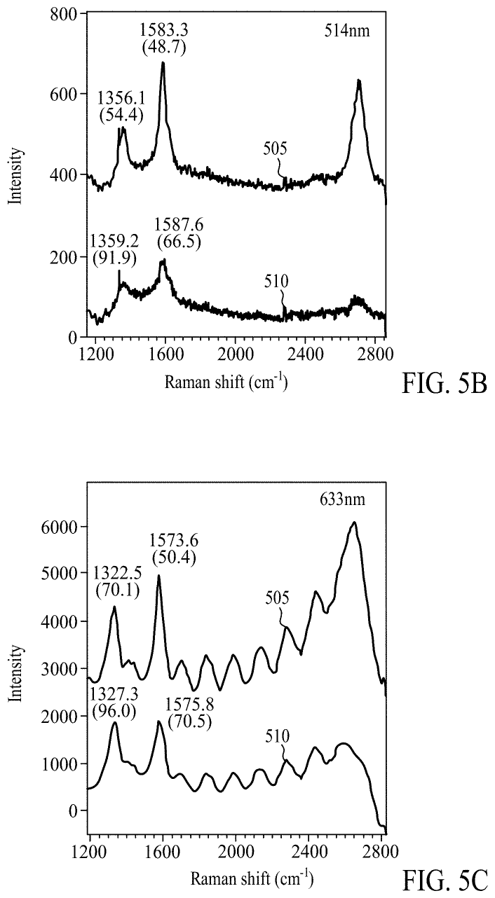

FIGS. 5A-5C are Raman spectra of comparative carbon nanotubes 505 and example boron-carbon containing nanotubes 510 at various excitation wavelengths—488 nm, 514 nm, and 633 nm. The baseline has been removed in FIGS. 5A-5C. The Raman spectra confirmed that the nanotubes are boron doped. For example, significant reduced 2D band density was observed for the boron-carbon containing examples. Moreover, up-shifting of the G-band and D-band for all excitation wavelengths is indicative of p-type doping, e.g., boron doping. Further, broadening of both the G-band and the D-band indicate loss of the crystalline structure as a result of boron-doping.

### Example 2C: Deposition of Lithium on Substrate from Example 2B

Deposition of the lithium metal on the substrate of Example 2B is performed according to the following prophetic procedure. The electrochemical reaction can be performed in 2032 coin-type cells using substrate of Example 2B and Li foil as both counter and reference electrodes. The substrates are circular with total area of about 2 cm². The electrolyte is 4M lithium LiFSI in 1,2-dimethoxyethane (DME). The LiFSI salt is vacuum-dried (<20 Torr) at 100° C. for 24 h, and DME can be distilled over Na strips. The experiment is conducted inside a glovebox with oxygen levels below 5 ppm. The separator is Celgard™ membrane K2045. Previous to the coin-cell assembly, the substrate is pre-lithiated by putting one drop of electrolyte on the surface of substrate, pressing a Li coin gently against the substrate and leaving it with the Li coin on top for 3 h. After the pre-lithiation, the substrate is assembled in a coin cell using the same Li chip used in the pre-lithiation. The current density for the electrochemical measurements (insertion/extraction and cycling) ranges from 1 to 10 mA cm⁻², all performed at room temperature. For the Li plating (discharging process), a time-controlled process with a constant current regime is applied with no cutoff voltage limit. The stripping process (charge process) is set to a constant current regime with a cutoff voltage of 1 V (vs Li⁺/Li).

Advantageously, the lithium metal based electrode includes a boron-carbon containing nanostructure that can eliminate, or at least suppress, lithium dendrite formation during charge-discharge cycling. As such, the lithium metal based electrodes provided herein can have improved lifetime and improved safety over conventional lithium metal based electrodes.

### Aspects Listing

The present disclosure provides, among others, the following aspects, each of which can be considered as optionally including any alternate aspects:

Clause 1. An electrode, comprising: a current collector layer; a boron-carbon containing nanostructure; and a lithium metal layer.

Clause 2. The electrode of Clause 1, wherein the boron-carbon containing nanostructure is selected from the group consisting of boron-carbon containing nanotube, boron-carbon containing graphene, boron-carbon containing fiber, boron-carbon containing nanofiber, boron-carbon containing hexagonal sheet, boron-containing meso-phase carbon, boron-containing soft carbon, boron-containing hard carbon, boron-containing carbon black, boron-containing activated carbon, and a combination thereof.

Clause 3. The electrode of Clause 1 or Clause 2, wherein the boron-carbon containing nanostructure is disposed on at least a portion of the current collector layer.

Clause 4. The electrode of any one of Clauses 1-3, wherein the lithium metal layer is disposed on at least a portion of the boron-carbon containing nanostructure.

Clause 5. The electrode of any one of Clauses 1-4, wherein the boron-carbon containing nanostructure comprises boron-carbon containing nanotubes.

Clause 6. The electrode of any one of Clauses 1-5, wherein the boron-carbon containing nanostructure comprises boron-carbon containing graphene.

Clause 7. The electrode of Clause 6, wherein the boron-carbon containing nanostructure further comprises boron-carbon containing nanotubes.

Clause 8. The electrode of any one of Clauses 1-7, wherein the current collector layer comprises aluminum, copper, nickel, or a combination thereof.

Clause 9. The electrode of any one of Clauses 1-8, wherein the boron-carbon containing nanostructure has a molar ratio of boron to carbon of about 1:100 to about 1:3.

Clause 10. The electrode of Clause 9, wherein the molar ratio of boron to carbon is from about 1:20 to about 1:3.

Clause 11. An electrode, comprising: a current collector layer; boron-carbon containing graphene; and a lithium metal layer.

Clause 12. The electrode of Clause 11, wherein: the boron-carbon containing graphene is disposed on at least a portion of the current collector layer; and the lithium metal layer is disposed on at least a portion of the boron-carbon containing graphene.

Clause 13. The electrode of Clause 11 or Clause 12, wherein the current collector layer is selected from the group consisting of aluminum, copper, nickel, and a combination thereof.

Clause 14. The electrode of any one of Clauses 11-13, wherein the current collector layer comprises copper.

Clause 15. The electrode of any one of Clauses 11-14, wherein the boron-carbon containing graphene has a molar ratio of boron to carbon from about 1:100 to about 1:3.

Clause 16. The electrode of Clause 15, wherein the molar ratio of boron to carbon is from about 1:20 to about 1:3.

Clause 17. An electrode, comprising: a current collector layer; graphene; a plurality of boron-carbon containing nanotubes; and a lithium metal layer.

Clause 18. The electrode of Clause 17, wherein: the graphene is disposed on at least a portion of the current collector layer; the plurality of boron-carbon containing nanotubes is disposed on at least a portion of the graphene; and the lithium metal layer is disposed on at least a portion of the plurality of boron-carbon containing nanotubes.

Clause 19. The electrode of Clause 17 or Clause 18, wherein the current collector layer comprises aluminum, copper, nickel, or a combination thereof.

Clause 20. The electrode of any one of Clauses 17-19, wherein the plurality of boron-carbon containing nanotubes has a molar ratio of boron to carbon from about 1:100 to about 1:3.

Clause 21. A battery, comprising: an anode; and a cathode comprising an electrode, the electrode comprising: a current collector layer; a boron-carbon containing nanostructure; and a lithium metal layer.

Clause 22. The battery of Clause 21, wherein the cathode and the anode are substantially free of dendrites.

Clause 23. A process for producing an electrode, comprising: depositing a first carbon source on a metal substrate to form graphene; depositing a metal catalyst on the graphene; introducing a boron source and a second carbon source to the metal catalyst to form a boron-carbon containing nanotube; and depositing lithium on the boron-carbon containing nanotube to produce an electrode.

All documents described herein are incorporated by reference herein, including any priority documents and/or testing procedures to the extent they are not inconsistent with this text. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure. As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, e.g., the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art.

As used herein, the indefinite article “a” or “an” shall mean “at least one” unless specified to the contrary or the context clearly indicates otherwise. For example, aspects comprising “a layer” include aspects comprising one, two, or more layers, unless specified to the contrary or the context clearly indicates only one layer is included.

When an element or layer is referred to as being “on” or “above” another element or layer, it includes the element or layer that is directly or indirectly in contact with the another element or layer. Thus it will be understood that when an element is referred to as being “on” another element, it can be directly on the other element or intervening elements may be present therebetween. In contrast, when an element is referred to as being “directly on” another element, there are no intervening elements present.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

What is claimed is:

1. An electrode, comprising:
a current collector layer;
a boron-carbon containing nanostructure; and
a lithium metal layer.

2. The electrode of claim 1, wherein the boron-carbon containing nanostructure is selected from the group consisting of boron-carbon containing nanotube, boron-carbon containing graphene, boron-carbon containing fiber, boron-carbon containing nanofiber, boron-carbon containing hexagonal sheet, boron-containing meso-phase carbon, boron-containing soft carbon, boron-containing hard carbon, boron-containing carbon black, boron-containing activated carbon, and a combination thereof.

3. The electrode of claim 1, wherein the boron-carbon containing nanostructure is disposed on at least a portion of the current collector layer.

4. The electrode of claim 1, wherein the lithium metal layer is disposed on at least a portion of the boron-carbon containing nanostructure.

5. The electrode of claim 1, wherein the boron-carbon containing nanostructure comprises boron-carbon containing nanotubes.

6. The electrode of claim 1, wherein the boron-carbon containing nanostructure comprises boron-carbon containing graphene.

7. The electrode of claim 6, wherein the boron-carbon containing nanostructure further comprises boron-carbon containing nanotubes.

8. The electrode of claim 1, wherein the current collector layer comprises aluminum, copper, nickel, or a combination thereof.

9. The electrode of claim 1, wherein the boron-carbon containing nanostructure has a molar ratio of boron to carbon of about 1:100 to about 1:3.

10. The electrode of claim 9, wherein the molar ratio of boron to carbon is from about 1:20 to about 1:3.

11. An electrode, comprising:
a current collector layer;
boron-carbon containing graphene; and
a lithium metal layer.

12. The electrode of claim 11, wherein:
the boron-carbon containing graphene is disposed on at least a portion of the current collector layer; and
the lithium metal layer is disposed on at least a portion of the boron-carbon containing graphene.

13. The electrode of claim 11, wherein the current collector layer is selected from the group consisting of aluminum, copper, nickel, and a combination thereof.

14. The electrode of claim 11, wherein the current collector layer comprises copper.

15. The electrode of claim 11, wherein the boron-carbon containing graphene has a molar ratio of boron to carbon from about 1:100 to about 1:3.

16. The electrode of claim 15, wherein the molar ratio of boron to carbon is from about 1:20 to about 1:3.

17. An electrode, comprising:
a current collector layer;
graphene;
a plurality of boron-carbon containing nanotubes; and
a lithium metal layer.

18. The electrode of claim 17, wherein:
the graphene is disposed on at least a portion of the current collector layer;
the plurality of boron-carbon containing nanotubes is disposed on at least a portion of the graphene; and
the lithium metal layer is disposed on at least a portion of the plurality of boron-carbon containing nanotubes.

19. The electrode of claim 17, wherein the current collector layer comprises aluminum, copper, nickel, or a combination thereof.

20. The electrode of claim 17, wherein the plurality of boron-carbon containing nanotubes has a molar ratio of boron to carbon from about 1:100 to about 1:3.
